(19) United States
(12) Patent Application Publication
(10) Pub. No.: US 2009/0164482 A1
(43) Pub. Date: Jun. 25, 2009

(54) METHODS AND SYSTEMS FOR OPTIMIZING PROJECTION OF EVENTS

(76) Inventors: Partha Saha, Oakland, CA (US); Vijay Raghunathan, San Francisco, CA (US); Krishna Ramachandran, Sunnyvale, CA (US); Ambikeshwar Raj Merchia, Cupertino, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 11/961,255

(22) Filed: Dec. 20, 2007

(51) Int. Cl. G06F 17/30

(52) U.S. Cl. 707/100; 707/E17.044

(57) ABSTRACT

Systems and methods for optimizing the projection of events are set forth in this disclosure. More specifically, systems and methods for projecting event data from one or more containers are set forth in this disclosure.

### BACKGROUND

Increasingly, an abundance of business intelligence data is gathered from the Internet and other information sources. Much of this data takes the form of information describing an action or occurrence (i.e., an event) that is typically generated by a user or a computer. Event data, including but not limited to data that may be associated with or derived from events, is often transmitted and stored for later access, identification, manipulation, or processing.

In many cases, event data may be related and/or share common properties. To exploit related and/or shared properties, event data is often transmitted and stored so as to preserve these related or shared common properties. Commonly, event data is organized into nested logical hierarchical structures (e.g., utilizing arrays and hash-maps) that are serialized or represented as a series of bytes. For example, event data may be transmitted or stored as a text-based log where a single line of serialized event data comprises a series of bytes (e.g., an 128 KB line of event data). As another example, serialized event data may comprise a series of bits that may be transmitted and/or reconstructed to represent a series of bytes.

### SUMMARY

Disclosed herein are systems and methods that have been developed for optimizing the projection of events. In one embodiment (which embodiment is intended to be illustrative and not restrictive), a method for optimizing the projection of events is provided. The method includes organizing event data fields of an event record into a nested logical hierarchy according to a schema. The method further includes assembling the event data fields into one or more containers, each of the one or more containers including at least type information, implicit or explicit length information, and value information and preserving the nested logical hierarchy of the event data fields according to the schema. The method yet further includes identifying type information and implicit or explicit length information of a first container. The method still further includes, based upon the identified type information and the implicit or explicit length information of the first container, skipping to a second container. The method further includes identifying type information and implicit or explicit length information of the second container. The method yet further includes, based upon the identified type information and the implicit or explicit length information of the second container, projecting the value information from the second container. Instead of de-serializing or materializing an entire logical hierarchy and information comprising event data, in data processing environments, it is often necessary to project or extract a small portion of event data that may be buried within the nested logical hierarchy of event data.

In one aspect, the method includes serializing the one or more containers into an event stream. In another aspect, the method includes projecting value information from at least one of the one or more containers without de-serializing the event stream. In yet another aspect of the method, assembling the event data fields into one or more containers includes segregating the type information and implicit or explicit length information into a header section of the one or more containers. In still another aspect of the method, assembling the event data fields into one or more containers includes segregating the value information into a body section of the one or more containers. In another aspect, the method includes, based upon the type information and implicit or explicit length information in the header section of the one or more containers, skipping to the value information. In yet another aspect, the method includes projecting the value information from the one or more containers. In still another aspect of the method, the value information comprises an event data field. In another aspect of the method, the value information corresponds to a primitive type. In yet another aspect of the method, the value information corresponds to a string value. In still another aspect of the method, the projected value information corresponds to a third container. In another aspect of the method, at least one of the one or more containers includes type information of a primitive type and implicit length information corresponding to a fixed-length of the primitive type. In yet another aspect of the method, at least one of the one or more containers includes type information of a non-primitive type and explicit length information corresponding to the length of the value information. In still another aspect, the method includes reading the value information projected from the second container. In another aspect, the method includes storing the value information projected from the second container. In yet another aspect, the method includes transforming the value information projected from the second container. In still another aspect, the method includes removing the value information projected from the second container. In another aspect, the method includes receiving a query to project value information corresponding to an event data field, the query identifying type information associated with the event data field.

In one embodiment (which embodiment is intended to be illustrative and not restrictive), a system for optimizing the projection of events is provided. The system includes one or more collection modules that collect event data, assemble the event data into one or more hierarchically-arranged event logs and serialize the one or more hierarchically-arranged event logs into a plurality of serialized data streams, each of the plurality of serialized data streams preserving the hierarchical arrangement of the hierarchically-arranged event logs and the event logs including at least type information, implicit or explicit length information, and value information corresponding to each event. The system further includes one or more query modules that query at least one of the plurality of serialized data streams to project the value information corresponding to an event out of the plurality of serialized data streams.

In one aspect, the system includes one or more archive modules that archive the value information corresponding to the event projected out of the plurality of serialized data streams. In another aspect, the system includes a storage module that stores the plurality of serialized data streams. In yet another aspect of the system, the serialization of event logs into serialized data streams by the one or more collection modules further includes multiplexing one or more streams of event data received by the one or more collection modules.

In one embodiment (which embodiment is intended to be illustrative and not restrictive), a method for optimizing the projection of events is provided The method includes assembling event data fields of an event record into at least one container having a nested logical hierarchy according to a schema, the at least one container having a header section that includes type information and implicit or explicit length information and a body section that includes value information. The method further includes, based upon the schema, identifying the type information and the implicit or explicit length information of an event data field in the header section of the container. The method yet further includes, based upon the identified type information and the implicit or explicit length information of the event data field in the header section of the container, skipping to the value information of the event data field.

In one aspect, the method includes projecting the value information of the event data field. In another aspect of the method, the size of the container corresponds to the size of a memory architecture. In yet another aspect of the method, the memory architecture is an L1 or L2 cache.

In one embodiment (which embodiment is intended to be illustrative and not restrictive), a computer readable medium comprising a method for optimizing the projection of events is provided. The method includes instructions for organizing event data fields of an event record into a nested logical hierarchy according to a schema. The method further includes instructions for assembling the event data fields into one or more containers, each of the one or more containers including at least type information, implicit or explicit length information, and value information and preserving the nested logical hierarchy of the event data fields according to the schema. The method yet further includes instructions for identifying type information and implicit or explicit length information of a first container. The method still further includes instructions, based upon the identified type information and the implicit or explicit length information of the first container, for skipping to a second container. The method further includes instructions for identifying type information and implicit or explicit length information of the second container. The method yet further includes instructions, based upon the identified type information and the implicit or explicit length information of the second container, for projecting the value information from the second container.

These and various other features as well as advantages will be apparent from a reading of the following detailed description and a review of the associated drawings. Additional features are set forth in the description which follows, and in part will be apparent from the description, or may be learned by practice of the described embodiments. While it is to be understood that both the foregoing general description and the following detailed description are exemplary and explanatory, the benefits and features will be realized and attained by the structure particularly pointed out in the written description and claims hereof as well as the appended drawings.

### BRIEF DESCRIPTION OF THE DRAWINGS

The following drawing figures, which form a part of this application, are illustrative of embodiments systems and methods described below and are not meant to limit the scope of this disclosure in any manner, which scope shall be based on the claims appended hereto.

FIG. 1 illustrates an embodiment of a system for optimizing the projection of events.

FIG. 2 illustrates an embodiment of a method for optimizing the projection of events.

FIG. 3 illustrates an embodiment of another method for optimizing the projection of events.

### DETAILED DESCRIPTION

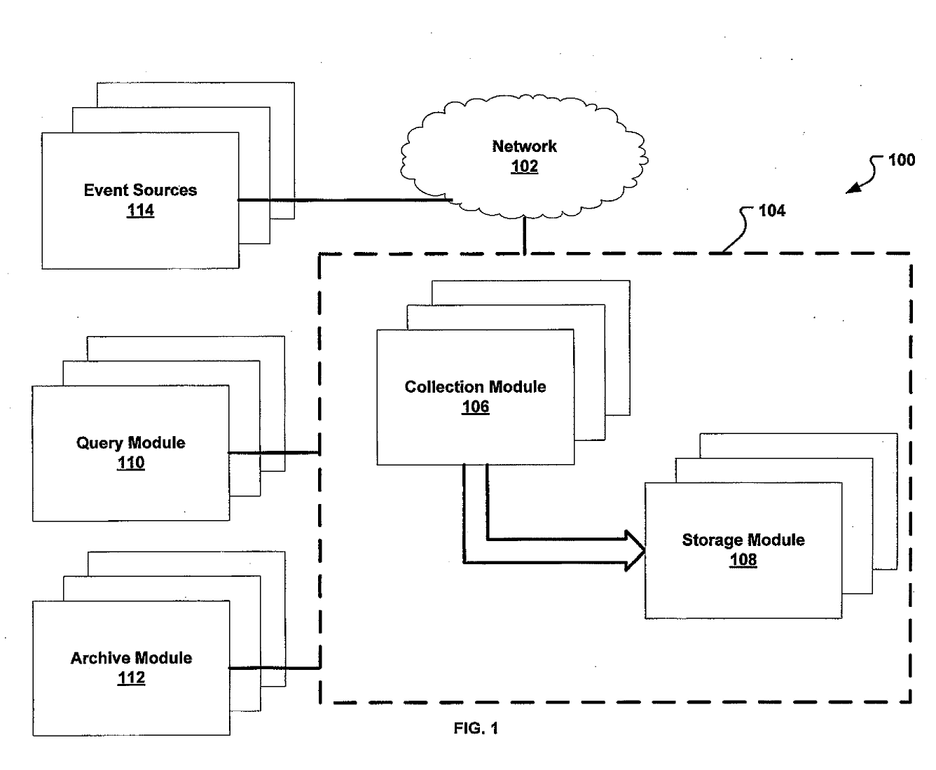

FIG. 1 illustrates an embodiment of a system 100 for optimizing the projection of events. In the system 100, one or more collection modules 106 collect event data from a network 102. In one embodiment, event data may include event data (i.e., lines of logged events) logged and/or streamed by web servers. A server may be a single server or a group of servers acting together. A number of program modules and data files may be stored in a mass storage device and RAM of a server, including an operating system suitable for controlling the operation of a networked server computer, such as the WINDOWS XP or WINDOWS 2003 operating systems from MICROSOFT CORPORATION. Additionally, one or more processes typically run on a server. In an embodiment, the one or more collection modules 106 may utilize one or more processes for collecting event data streamed from one or more event sources 114. In an embodiment, event sources 114 comprise one or more servers that collect data (i.e., event data) representing user activity on the Internet. In one embodiment, the collection modules 106 assemble the event data into one or more hierarchically-arranged event logs (e.g., organizing utilizing arrays and hash maps that may be nested several layers deep) and serialize the one or more hierarchically-arranged event logs into a plurality of serialized event or data streams. In another embodiment, the collection modules 106 may receive a plurality of event streams including already serialized event data, or some combination thereof Each of the plurality of serialized event streams preserves the arrangement of the hierarchically-arranged event data. In one embodiment, serialization of event logs into serialized event streams may further comprise multiplexing one or more streams of event data received by the one or more collection modules 106. For example, the one or more collection modules 106 may receive various streams of event data (e.g., event data derived from advertising, mail and/or database information) from a network 102 that may be multiplexed so as to indicate a source, a user associated with the event data or some other identifying information. In the embodiment of the system 100, a serialized data stream may include event data that is divided so as to preserve the structure or representation of advertising (i.e., pay-per-click events) and database (i.e., user attributes) information.

In one embodiment of the system 100, the plurality of serialized event streams may be stored in a storage module 108. The storage module 108 may also store extracted or projected event data. Local data structures, including discrete media objects such as media files, may be stored on a mass storage device, such as the storage module 108. One or more mass storage devices may be connected to, or be part of, any of the devices described herein. The mass storage device includes some form of computer-readable media and provides non-volatile storage of data for later use by one or more computing devices. Although the description of computer-readable media contained herein refers to a mass storage device, such as a hard disk or CD-ROM drive, it should be appreciated by those skilled in the art that computer-readable media may be any available media that can be accessed by a computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and that can be accessed by the computer.

One or more queries may occur at different stages in the global formation, transmission and storage of serialized event streams 104. For example, a query module may query a serialized event stream upon its formation within the one or more collection modules 106, upon storage at a storage module 108, or upon being transmitted thereto. In one aspect, a query may identify event data. Where serialized event data comprises information that may identify or detect whether a user interacted with a web page or initiated an event, the query may include information identifying event data associated with the user. In another aspect, the query may comprise information that may be used to determine whether a certain portion of a serialized event stream matches some criteria. For example, a query may test whether a serialized data stream includes information regarding users with a certain event history or subscription level. In an embodiment, the system 100 may archive information received in response to queries from a query module 10 within an archive module 112.

In one embodiment (not shown), collection module 106, storage module 108, query module 110, and archive module 112 may be co-located on a single computing device or similar unified computing architecture. As illustrated in FIG. 1, query module 110 and archive module 112 are illustrated as separate units and discussed as separate computing elements for the purpose of describing the generation of queries by query module 110, the archival of information by archive module 112 and the communications between the two servers. However, it will be appreciated with those with skill in the art that the separate computing elements may occur in software, hardware, and or/firmware modules located within a single computing device or within a network of unified computing devices, and communications there-between may occur across modules, within modules, or in any combination thereof. For example, in an alternative embodiment collection module 106 may transmit serialized event streams to a remote computing device that may comprise a storage module 108. Thus, various functions described with reference to the embodiment shown in FIG. 1 may be distributed between different computing devices. As another example, a query module 110 may transmit queries for processing directly to a remote computing device that may comprise storage module 108. The query module 110 may also transmit queries for archival to another remote computing device that may comprise an archive module 112.

Elements of the systems described herein may be implemented in hardware, software, firmware, any combination thereof, or in another appropriate medium. The systems described herein may implement methods described herein. In addition, methods described herein when implemented in hardware, software, firmware, any combination thereof, or in another appropriate medium may form systems described herein.

The descriptions of the methods and systems herein supplement each other and should be understood by those with skill in the art as forming a cumulative disclosure. Methods and systems, though separately claimed herein, are described together within this disclosure. For example, the parts of the methods described herein may be performed by systems (or parts thereof) described herein.

In addition, the methods described herein may be performed iteratively, repeatedly, and/or in parts, and some of the methods or parts of the methods described herein may be performed simultaneously. In addition, elements of the systems described herein may be distributed geographically or functionally in any configuration.

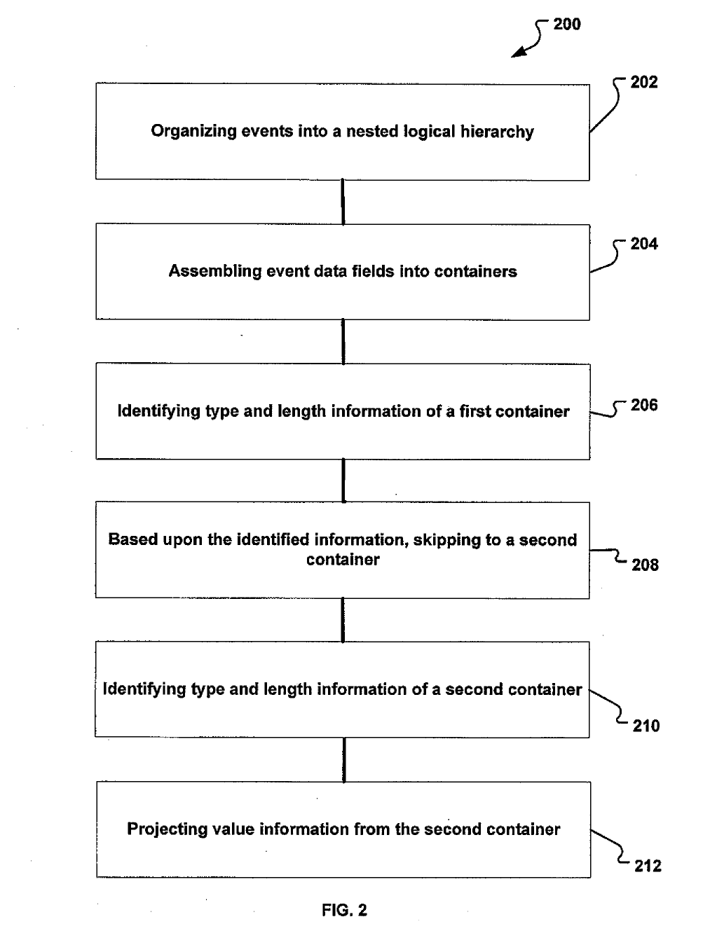

FIG. 2 illustrates an embodiment of a method 200 for optimizing the projection of events. In an organizing operation 202 of method 200, event data fields of an event record are organized into a nested logical hierarchy according to a schema. Event data typically include data that is gathered from the Internet and other information sources. Event data may describe an action or occurrence (i.e., an event) that is generated by a user or a computer. For example, event data may be comprised of web page information (e.g., including but not limited to information about web page elements). As another example, event data may be comprised of activity information (e.g., including but not limited to information describing selection of web page elements, navigation to and from web pages, history of interaction with a web page, and input and output associated with utilization of a web page). As yet a filter example, event data may be comprised of information identifying or supplied by a user or describing a user or a user's interaction with a web page. One skilled in the art will recognize that many other types of event data may exist within the scope of this disclosure. Event data, including but not limited to data that may be associated with (i.e., describing events) or derived from events, may be transmitted and stored for later access, identification, manipulation, or processing. An event may be comprised of information describing one or more other events. Events may be nested hierarchically within other events. For example, an event log may represent event data information hierarchically, relationally or by another arrangement such that each line of the event log may represent an event. In one aspect, a single line of an event log may be as large as 128 kB in size. In other aspects, event logs may include event data of varying, smaller or larger sizes. In one embodiment, event data may include arrays and hash-maps that may be nested several layers deep.

In an assembling operation 204 of method 200, event data fields are assembled into one or more containers that include at least type information, implicit or explicit length information, and value information and that preserve the nested logical hierarchy of the event data fields according to the schema. In one embodiment, value information may include primitive (e.g., char, ints, double) type value information, container (e.g., arrays, hash maps, objects, event data fields, etc.) type value information, containers of primitives and/or containers of containers type value information. In another aspect of the method 200, assembling the event data fields into one or more containers may comprise segregating the type information and implicit or explicit length information into a header section of the one or more containers and segregating the value information into a body section of the one or more containers. The header and/or body sections of the one or more containers may correspond to a memory architecture. For example, one or more containers may be adapted so that one or more containers correspond to a logical or physical memory architecture, such as an L1 and L2 cache architecture. Adaptation to a memory architecture may provide cache locality (for cases involving a cache), and thereby may reduce the time necessary for projection. Specifically, adapting the serialization of event logs to memory architectures may lead to faster projection of event data by consuming fewer processing cycles and/or requiring fewer transfers between lower-speed memory and one or more processors. Event data fields within one or more containers are further assembled to preserve a hierarchical arrangement in accordance with a schema. For example, a schema may be comprised of:

Event→(Column)*

Column→[Name,]Value

Value→List|Map|Primitive

List→(Map)*|(One-Primtitive-Type)*

Map→([Name,]Value)*

Further to this example, a “[Name,]” implies a name that may come from a schema showing the event data type expected as a “Value” for a “Column,” “Map,” or as a “List” element. A “[Name,]” may also correspond to the names associated with the columns and the keys in a map (and that may be omitted in an event record). As another example, an event may be represented by a 1 byte header of a first portion of a serialized data stream that may include 5 bits for type information (e.g., List|Map|boolean|int32|int64|uint32|uint64|double|string) and 3 bits for length information (e.g., the length of value information of a List or Map type).

In a identifying operation 206 of the method 200, type information and implicit or explicit length information of a first container is identified. Type information and value information representing an event may comprise fields of a length that is implicitly known based upon the type information and/or value information. For example, a primitive type, such as an integer, may have value information that is implicitly known to be of a fixed or predetermined length. Alternately, type information and value information may comprise fields of variable length such that the length of the type information and/or value information fields may be explicitly set forth by a length information field. For example, a length information field, that may itself be a fixed- or variable-length field, may explicitly or expressly set forth the length of a variable-sized value information field. In one embodiment, length information may be implicitly and/or explicitly stated. In another embodiment, the implicit and/or explicit length information may be used to iterate through event data that is stored within the one or more containers.

In a skipping operation 208 of the method 200, the identified type information and implicit or explicit length information is used to skip to a second container. For example, where the one or more containers are serialized within a data stream, skipping operation 208 may include identification of first container type of a predetermined length (e.g., a length corresponding to a primitive type). Since the extent of the data (of a predetermined length) is known, the type and length information may permit skipping to a second container. Where, as described previously, the one or more containers employs sections (i.e., a header section and body section) to segregate type and length information from value information, skipping may comprise identification of an offset in a header and skipping to the respective part of the body based upon the offset. For example, where the value information itself comprises one or more (nested) containers, the offset may identify one of the nested containers.

In an identifying operation 210 of the method 200, type information and the implicit or explicit length information of a second container is identified. For example, identification of type information may comprise comparing type information values for a plurality of containers and/or events within a serialized data stream. As another example, identification of type information may comprise detecting, signaling and/or copying a container and/or event with matching type information to memory.

In a projecting operation 212 of the method 200, based upon the type information and the implicit or explicit length information identified in identifying operation 206, the value information from the first container is projected. Projection of value information may include extracting, producing, transmitting and/or utilizing the value information, which may include one or more event data fields or other containers. In one embodiment, projection of the value information, as well as identification of the type information, may occur without de-serialization of a serialized data stream. For example, a serialized data stream may be monitored for certain type information, whereupon the corresponding value information may be extracted when the certain type information is found. One skilled in the art will recognize that projection may take other forms that are also within the scope of this disclosure. In one embodiment, the projected information may correspond to a primitive type. For example, a primitive type may include a boolean, integer, double, or string value. In another embodiment, the projected information may correspond to or include other (i.e., nested) event data. In yet another embodiment, where each of the plurality of events is further comprised of length information, projection may encompass projecting the value information corresponding to the length information for the event. For example, where type information comprises a non-primitive type, the length information may specify the length of data comprising an event's value information. Further to this example, where an event comprises type information indicating an array or hash-map (e.g., for another event), length information may indicate the length of the array or hash-map set forth as its value information.

Another aspect of method 200 may comprise serializing event logs (e.g., as lines of text) in one or more containers (e.g., text files). In yet another embodiment, the method 200 may further comprise updating, reading, storing, transforming and/or removing the projected value information. For example, value information projected from an event may be updated (e.g., replaced with new value information). As another example, value information projected from an event may be read from a serialized data stream. Particularly with respect to large serialized data streams, reading value information without de-serializing an entire serialized data stream may save substantial processing time. Where events are comprised of type information and length information, the length information corresponding to a first event may be used to iterate to a second event where the type information for the first event does not comport with the sought after type information. As another example, projected value information may be stored in an event buffer or on remote computing device for later processing and/or analysis. One skilled in the art will recognize that projected information may be utilized in various other ways within the scope of this disclosure.

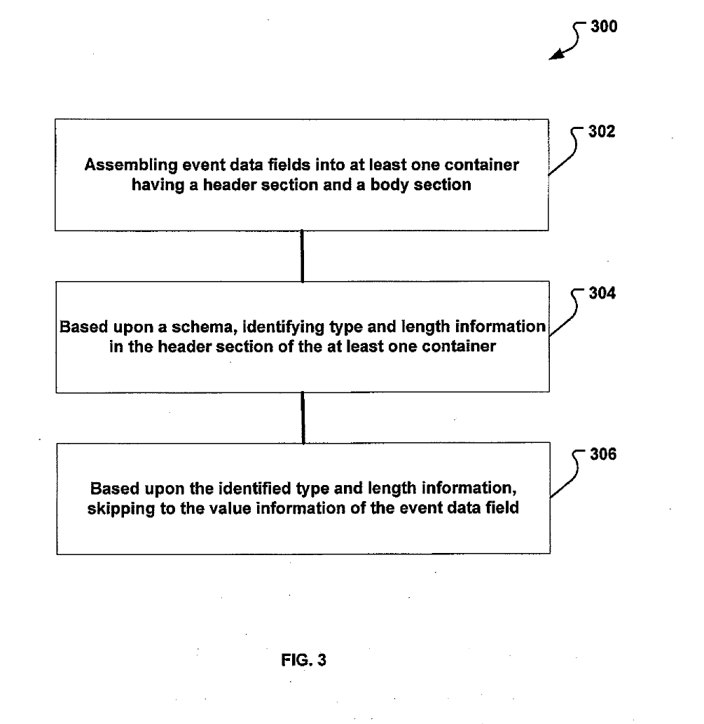

FIG. 3 illustrates an embodiment of another method 300 for optimizing the projection of events. In an assembling operation 302 of method 300, event data fields of an event are assembled into at least one container having a nested logical hierarchy according to a schema. In the embodiment, the at least one container has a header section that includes type information and implicit or explicit length information and a body section that includes value information corresponding to the event data fields. In one embodiment, type information and value information is associated with at least a portion of the event data within a container. Containers, as discussed above, may correspond to a memory architecture (i.e., memory architecture size) such as an L1 or L2 cache.

In an identifying operation 304 of the method 300, type information and length information may be identified based upon the schema. For example, a first container may be identified (i.e., within a data stream) that includes the type information associated with a first type of event data. For example, identification of a container may include identification of a certain array or hash map value. As another example, identification of a container may include identification of some primitive type (e.g., a string) whose value may include or point to information corresponding to the container. As discussed previously, the identification of the type information and implicit or explicit length information may then be used to skip to value information (i.e., the event data field) in a skipping operation 306.

In another embodiment of the method 300, based upon implicit or explicit length information of the first container, the value information associated with the first type of event data is projected from the first container. In one embodiment, projecting the value information associated with the first event may comprise detecting the type information associated with the first event. For example, detection of type information indicating a 32-bit integer value may provide sufficient detail to project the value information containing the 32-bit integer from the serialized data stream. In another embodiment, detecting the type information associated with the first event may further comprise iterating through the serialized data stream to detect the type information associated with the first event. In yet another embodiment, detecting the type information associated with the first event may further comprise monitoring the serialized data stream to detect the type information associated with the first event. As an example, where a serialized data stream is transmitted to a receiving device, one or more components of the receiving device may perform a “gatekeeper” function so as to monitor the incoming/received serialized data stream for an event of the type that corresponds to the type information.

In one aspect, the method 300 may further comprise identifying a second container (i.e., within a serialized data stream). The second container may include the type information associated with the first type of event data. The method 300 may then further include, based upon implicit or explicit length information of the second container, projecting the value information associated with the identified second container.

In another aspect, the method 300 may further comprise receiving a query to project a second type of event data from the serialized data stream. In an embodiment, the query may identify type information associated with the second type of event data. In one aspect, the method may also include signaling an error condition upon failing to detect the second type of event data from the serialized data stream.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of this disclosure. For example, projection of serialized events may permit more efficient use of multi-core processors with access to a plurality of cache resources. As another example, optimizing event projection may match the memory architecture of a distributed computing network such that event data is apportioned in a serialized data stream such that it matches the memory capacity of one or more connected computing devices that form a portion of the distributed computing network.

Numerous other changes may be made which will readily suggest themselves to those skilled in the art and which are encompassed in the spirit of this disclosure and as defined in the appended claims.

What is claimed is:

1. A method for optimizing the projection of events comprising:
organizing event data fields of an event record into a nested logical hierarchy according to a schema;
assembling the event data fields into one or more containers, each of the one or more containers including at least type information, implicit or explicit length information, and value information and preserving the nested logical hierarchy of the event data fields according to the schema;
identifying type information and implicit or explicit length information of a first container;
based upon the identified type information and the implicit or explicit length information of the first container, skipping to a second container;
identifying type information and implicit or explicit length information of the second container; and
based upon the identified type information and the implicit or explicit length information of the second container, projecting the value information from the second container.

2. The method of claim 1 further comprising:
serializing the one or more containers into an event stream.

3. The method of claim 2 further comprising:
projecting value information from at least one of the one or more containers without de-serializing the event stream.

4. The method of claim 1 wherein assembling the event data fields into one or more containers comprises:
segregating the type information and implicit or explicit length information into a header section of the one or more containers; and
segregating the value information into a body section of the one or more containers.

5. The method of claim 4 further comprising:
based upon the type information and implicit or explicit length information in the header section of the one or more containers, skipping to the value information; and
projecting the value information from the one or more containers.

6. The method of claim 1 wherein the value information comprises an event data field.

7. The method of claim 6 wherein the value information corresponds to a primitive type.

8. The method of claim 6 wherein the value information corresponds to a string value.

9. The method of claim 1 wherein the projected value information corresponds to a third container.

10. The method of claim 1 wherein at least one of the one or more containers includes type information of a primitive type and implicit length information corresponding to a fixed-length of the primitive type.

11. The method of claim 1 wherein at least one of the one or more containers includes type information of a non-primitive type and explicit length information corresponding to the length of the value information.

12. The method of claim 1 further comprising:
reading the value information projected from the second container.

13. The method of claim 1 further comprising:
storing the value information projected from the second container.

14. The method of claim 1 further comprising:
transforming the value information projected from the second container.

15. The method of claim 1 further comprising:
removing the value information projected from the second container.

16. The method of claim 1 further comprising:
receiving a query to project value information corresponding to an event data field, the query identifying type information associated with the event data field.

17. A system for optimizing projection of events comprising:
one or more collection modules that collect event data, assemble the event data into one or more hierarchically-arranged event logs and serialize the one or more hierarchically-arranged event logs into a plurality of serialized data streams, each of the plurality of serialized data streams preserving the hierarchical arrangement of the hierarchically-arranged event logs and the event logs including at least type information, implicit or explicit length information, and value information corresponding to each event; and
one or more query modules that query at least one of the plurality of serialized data streams to project the value information corresponding to an event out of the plurality of serialized data streams.

18. The system of claim 17 further comprising:
one or more archive modules that archive the value information corresponding to the event projected out of the plurality of serialized data streams.

19. The system of claim 17 further comprising:
a storage module that stores the plurality of serialized data streams.

20. The system of claim 17 wherein the serialization of event logs into serialized data streams by the one or more collection modules further comprises multiplexing one or more streams of event data received by the one or more collection modules.

21. A method for optimizing the projection of events comprising:
assembling event data fields of an event record into at least one container having a nested logical hierarchy according to a schema, the at least one container having a header section that includes type information and implicit or explicit length information and a body section that includes value information;
based upon the schema, identifying the type information and the implicit or explicit length information of an event data field in the header section of the container; and
based upon the identified type information and the implicit or explicit length information of the event data field in the header section of the container, skipping to the value information of the event data field.

22. The method of claim 21 further comprising:
projecting the value information of the event data field.

23. The method of claim 21 wherein the size of the container corresponds to the size of a memory architecture.

24. The method of claim 23 wherein the memory architecture is an L1 or L2 cache.

25. A computer readable medium comprising a method for optimizing the projection of events, the method comprising instructions for:
organizing event data fields of an event record into a nested logical hierarchy according to a schema;
assembling the event data fields into one or more containers, each of the one or more containers including at least type information, implicit or explicit length information, and value information and preserving the nested logical hierarchy of the event data fields according to the schema;
identifying type information and implicit or explicit length information of a first container;
based upon the identified type information and the implicit or explicit length information of the first container, skipping to a second container;
identifying type information and implicit or explicit length information of the second container; and
based upon the identified type information and the implicit or explicit length information of the second container, projecting the value information from the second container.
